(19) United States
(12) Patent Application Publication
(10) Pub. No.: US 2003/0094473 A1
(43) Pub. Date: May 22, 2003

(54) Vehicle mounted flag pole holder

(76) Inventor: Murray E. Moore, Los Alamos, NM (US)

Correspondence Address: RODEY, DICKASON, SLOAN, AKIN & ROBB, PA, P.O. BOX 1888, ALBUQUERQUE, NM, 87103, US

(21) Appl. No.: 09/992,140

(22) Filed: Nov. 16, 2001

(51) Int. Cl. B60R 9/00; B60R 11/00

(52) U.S. Cl. 224/519

(57) ABSTRACT

A flagpole support, for use with a vehicle mounted receiver type hitch, including a tube-like member for supporting a flagpole, a support member, and a mechanism to securely fix the tube-like member to the support member. The support member has first and second ends, the first end of which has a cross section adapted to be telescopically received in the hitch opening. The first end of the support member also has a means to secure the support member to the receiver hitch. The second end of the support member includes the mechanism to securely fix the tube-like member. The length and wall thickness of the tube-like member and the mechanism to securely fix all support the load on the support when the tube-like member is supporting a flagpole with a flag and the vehicle is in motion at up to and including highway speeds. The support may further include additional tube-like members and mechanisms (including a cross member) to securely fix such tube-like members to the second end of the support member.

### FIELD OF THE INVENTION

This invention relates to apparatus for mounting a flagpole to a vehicle. More particularly, this invention relates to apparatus for coupling a flagpole holder to a conventional receiver type hitch attached to a vehicle.

### BACKGROUND OF THE INVENTION

Apparatus for attaching flag holders to vehicles is not new. U.S. Pat. Nos. 2,290,645 and 2,358,120 disclose flag staff holders for attachment to automobile bumpers. At least in the case of the first patent, the flag (referred to as “banner 73”) is relatively small. U.S. Pat. No. Des 427,108 discloses an ornamental design for vehicles. U.S. Pat. No. 4,002,138 discloses an auto safety flag and holder. Except for the type of design disclosed in this last patent, none of the foregoing, nor any other designs, are known to be in use. During recent patriotic demonstrations, it was noticed that private passenger automobiles and trucks had few convenient places for fastening flagpoles. Many vehicles had small flags tied to the automobile antenna, and some trucks mounted larger flagpoles onto the bed thereof or on a side view mirror.

Box receiver hitches, of the type which are bolted, welded or otherwise securely fastened to the frame of a vehicle (e.g., pickup trucks and sport utility vehicles (SUVs)) are well known and can be used for attaching a variety of devices. U.S. Pat. No. 6,179,184 discloses a hitch mounted cargo carrier. U.S. Pat. No. 5,938,092 discloses a hitch mounted drawbar for extending the bed and enhancing the load carrying capacity of a pickup truck. U.S. Pat. No. 5,451,088 discloses a similar device, also attached to a box receiver hitch, to provide a cantilevered extension for a pickup. U.S. Pat. No. 5,800,294 discloses a portable basketball hoop attached to the back of a pickup. The use of a box receiver hitch to support a plurality of fishing pole holders is described in U.S. Pat. No. 5,205,466 (the “'466 Patent”), The holder of the '466 Patent includes a cross member (16) which is pivotally attached, at its midpoint, to the upper end of upright (14) by means of a hinge or bolt (28). A plurality of tubular members (38) are secured, such as by welding or fasteners to the cross member. The inner diameter of the tubular members are designed to receive the handles of fishing poles. Another fishing rod holder is disclosed in U.S. Pat. No. 5,815,976.

It is an object of the present invention to provide for a flagpole holder, which readily connects to box receiver hitches of the type commonly attached to vehicles.

It is another object of the present invention to provide for a flagpole holder for attachment to a vehicle, which is simple in design.

It is another object of the present invention to provide for a robust flag pole holder which will withstand the forces imported to it by at least one flag pole bearing a flag (such as the American flag) while the vehicle is moving at up to and including highway speeds.

The foregoing and other objects will be apparent from the description and claims which follow.

### SUMMARY OF THE INVENTION

A flagpole support, for use with a vehicle mounted receiver type hitch, including a tube-like member for supporting a flagpole, a support member, and a mechanism to securely fix the tube-like member to the support member. The tube-like member has a given length, a first end, a second end, and a wall thickness. The support member has first and second ends, the first end of which has a cross section adapted to be telescopically received in the hitch opening. The first end of the support member also has a means to secure the support member to the receiver hitch. The second end of the support member includes the mechanism to securely fix the tube-like member. The length and wall thickness of the tube-like member and the mechanism to securely fix all support the load on the support when the tube-like member is supporting a flagpole with a flag and the vehicle is in motion at up to and including highway speeds. The support may further include additional tube-like members and mechanisms to securely fix such tube-like members to the second end of the support member. The securing mechanism includes a cross-member securely attached to the second end of the support member. The cross-member has openings for closely receiving at least a portion of the tube-like members. The tube-like members are permanently secured in the openings.

### BRIEF DESCRIPTION OF THE DRAWINGS

FIG. 1 is a perspective view of the first embodiment of the trailer hitch flag pole holder of the present invention; and

FIG. 2 is a perspective view of the second embodiment of the trailer hitch flagpole holder of the present invention.

### DESCRIPTION OF THE PREFERRED EMBODIMENT

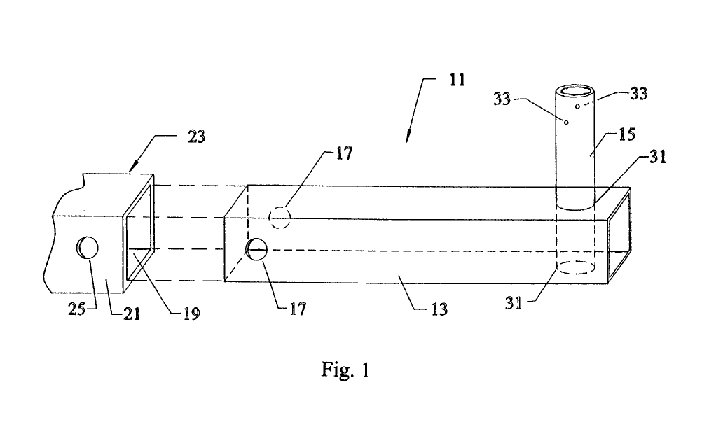

With reference to FIG. 1, flagpole support 11 includes a body member 13 and a tube-like member 15. The dimensions will vary depending on the specifications of the receiver hitch. In one embodiment, body member 13 is made of 2″ square cross-section steel tubing having, at one end (the front end) a first pair of aligned through apertures 17. This end is designed to be received in opening 19 of sleeve 21 of plug-in receiver hitch 23. Sleeve 21 also has a pair of aligned openings, one of which is illustrated at 25. Hitch 23 is attached (by any conventional structure, not shown) to a vehicle, such as an SUV or pickup truck (also not shown). The outside dimensions of body member 13 is slightly smaller than the inside dimensions of opening 19, to permit body member 13 to be telescopically received in sleeve 21, with apertures 17 aligned with apertures 25. Body member 13 is secured to sleeve 21 by, for instance, a lock pin (not shown). The back end of body member 13 includes a second pair of through openings 31.

Tube-like member 15 is, in one embodiment, a steel tube about 6 inches long, having a circular cross-section, an outside diameter of about 1.125 inches and inside diameter of, about, 1.00 inches. Member 15 is received in the back end of body member 17 in through openings 31 having a diameter slightly greater than the outside diameter of member 15. Preferably, member 15 is welded (by welds not shown) to body member 13 at both openings 31. Tube-like member 15 also includes a pair of aligned through holes 33 to receive a lock pin or bolt (not shown) to hold the flagpole (not shown) in place.

The thickness of the tubing used for body member 13, and the length and thickness of tube-like member 15 are chosen to provide a rigid structure which will support a flagpole bearing a flag and withstand the load such a flag pole and flag places on support 11 when the vehicle to which it is attached is moving a high way speeds. This is in contrast to the fishing pole holder of U.S. Pat. No. 5,205,446. The wind load on a fishing pole (which has very little wind drag resistance) would place less stress on the holder described in U.S. Pat. No. 5,205,446 than the holder of the present invention, which is designed to secure a flag moving at highway speeds.

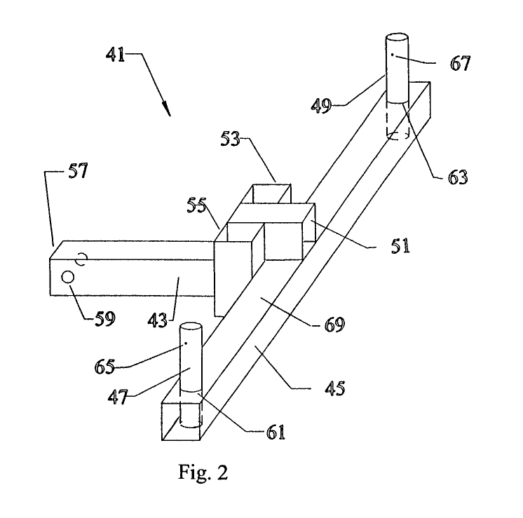

With reference to FIG. 2, flagpole support 41 includes a body member 43, a cross member 45, and first 47 and second 49 tube members. Cross member 45 is secured to support by any conventional rigid attachment. As illustrated, member 51 is attached, preferably by welding, to both body member 43 and cross member 45. Further, to provide additional structural support members 53 and 55 are secured, again preferably by welding, to body member 43, cross member 45 and member 51. Preferably, as illustrated, all of body member 43, cross member 45 and members 51, 53 and 55 are made of square tubular stock. As with the previous embodiment, front end 57 is designed to be telescopically received in opening 19 of sleeve 21 of plug-in receiver hitch 23. When connected, apertures 59 are aligned with apertures 25 via a locking pin (or equivalent) (not shown).

Tube-like members 47 and 49 can be, like the previous embodiment, be made of steel tubing about 6 inches long, having a circular cross section, an outside diameter of about 1.125 inches and an inside diameter of about 1.00 inches. Member 47 is received in a pair of aligned through openings 61 having a diameter slightly greater than the outside diameter of member 47 and, preferably, welded in place (by welds not shown). Similarly, member 49 is secured in a pair of through openings 63. Alternately, single openings in top surface 69 of cross member 45 can replace the aligned openings 61, 63. In this case, the bottom end (not shown) of each of tube-like members 47 and 49 will bottom out against the bottom inside surface of the square tubing used for cross member 45. If drainage is desired, drain holes can be drilled through the bottom of cross member 45 in the areas underneath the bottoms of tube-like members 47 and 49. Both numbers 47 and 49 have a pair of aligned openings, 65 and 67, to receive a lock pin, bolt or equivalent (not shown), to hold a flag pole (also not shown) in place. As before, the thickness of the tubing used for, for instance, body member 43 and cross member 45, and the length and thickness of tube-like members 47 and 49 are chosen to provide a rigid structure which will support a flagpole bearing a flag and withstand the load such a flag pole and flag places on support 41 when the vehicle to which it is attached is moving at highway speeds.

Whereas the drawings and accompanying description have shown and described the preferred embodiment of the present invention, it should be apparent to those skilled in the art that various changes may be made in the form of the invention without affecting the scope thereof. For instance, tube-like members 15, 47 and 49 could all have closed bottoms. The dimensions for the square structural tubing will vary depending on the specifications for the receiver hitch. This description also does not preclude the use of different bracing elements in the design to ensure structural integrity. Nor does it preclude more than two flagpole tube-like supports.

I claim:

1. A flagpole support for use with a hitch of the type having a receiver with an opening, said opening having a first cross-section, said receiver mounted to a vehicle, said support comprising:
a. a tube-like member for supporting a flag pole, said tube-like member having a length, a first end, a second end and a wall thickness;
b. a support member, said support member having first and second ends, said first end of said support member having a second cross section adapted to be telescopically received in said opening having said first cross section, said first end of said support member also having means to secure said first end of said support member to said receiver, said second end of said support member including means for supporting said tube-like member; and
c. means to securely fix said tube-like member to said second end of said support member, whereby said length, said wall thickness and said means to securely fix support the load on said tube-like member when said tube-like member is supporting a flag pole with a flag and said vehicle is in motion.

2. The support of claim 1, further including:
a. a second tube-like member, said second tube-like member having a length, a first end, a second end and a wall thickness; and
b. means to securely fix said second tube-like member to said second end of said support member.

3. The support of claim 2, wherein said means to securely fix said tube-like member to said support member and said means to securely fix said second tube-like member to said support member includes a cross-member securely attached to said second end of said support member.

4. The support of claim 3, wherein said tube-like member and said second tube-like member both have an exterior surface and said cross-member has a first opening for closely receiving at least a portion of said tube-like member, and a second opening for closely receiving at least a portion of said second tube-like member.

5. The support of claim 4, further including means to permanently attach said tube-like member in said first opening and said second tube-like member in said second opening.

6. A flagpole support for use with a hitch of the type having a receiver with an opening, said opening having a first cross-section, said receiver mounted to a vehicle, said support comprising:
a. a tube-like member for supporting a flag pole, said tube-like member having a length, a first end, a second end, an exterior surface, a wall thickness, and an interior;
b. a support member, said support member having first and second ends, said first end of said support member having a second cross section adapted to be received in said opening having said first cross section, said first end of said support member also having means to secure said first end of said support member to said receiver, said second end having an opening for closely receiving at least a portion of said tube-like member; and
c. means for permanently attaching said tube-like member in said opening.

7. A flagpole support for use with a hitch of the type having a receiver with an opening, said opening having a first cross-section, said receiver mounted to a vehicle, said support consisting essentially of:
a. a member for supporting a flag pole, said member having a length, a first end, a second end, and a flagpole supporting surface;
b. a support member, said support member having first and second ends, said first end of said support member having a second cross section adapted to be received in said opening having said first cross section, said first end of said support member also having means to secure said first end of said support member to said receiver; and
c. means for permanently attaching said members to said support member.

8. A flagpole support for use with a hitch of the type having a receiver with an opening, said opening having a first cross-section, said receiver mounted to a vehicle, said support comprising:
a. a plurality of tube-like members for supporting a like plurality of flag poles, each of said tube-like members having a length, a first end, a second end, an external surface, wall thickness and an internal cavity;
b. a cross member;
c. means for permanently securing said tube-like members to said cross member, said means for permanently securing, said length and said wall thickness being sufficient to withstand the load generated on said tube-like members and said means for permanently securing when a flag pole bearing a flag is received within said cavity and said vehicle is moving;
d. support member, said support member having first and second ends, said first end of said support member having a second cross section adapted to be received in said opening having said first cross section, said first end of said support member having means to secure said first end of said support member to said receiver, said second end of said support member including means for receiving said tube-like member; and
e. means for securing said cross member to said support member.
